(19) United States
(12) Patent Application Publication
(10) Pub. No.: US 2026/0309943 A1
(43) Pub. Date: Oct. 8, 2026

(54) ADAPTIVE THERMAL CONTROL FOR MICRO-RING MODULATORS IN PHOTONIC LINKS

(71) Applicant: Samsung Electronics Co., Ltd., Suwon-si (KR)

(72) Inventors: Yanhai REN, Arcadia, CA (US); Yibing Michelle WANG, Pasadena, CA (US); Hankyu LEE, Gyeonggi-do (KR); Woosung KIM, Gyeonggi-do (KR)

(21) Appl. No.: 19/415,764

(22) Filed: Dec. 10, 2025

Related U.S. Application Data
(60) Provisional application No. 63/782,940, filed on Apr. 3, 2025.

(51) Int. Cl. G02B 6/42; G02B 6/02; G02B 6/293

(52) U.S. Cl. CPC G02B 6/4266; G02B 6/02176; G02B 6/29338; G02B 6/29382; G02B 6/29395

(57) ABSTRACT

Provided are systems, methods, and apparatuses for adaptive thermal control for micro-ring modulator in photonic links. In one or more examples, the systems, devices, and methods include receiving a modulation data signal for driving the micro-ring modulator, generating a reference power value based on a duty cycle of the modulation data signal, and sensing an average optical power at a drop port of the micro-ring modulator. The systems, devices, and methods also include comparing the sensed average optical power to the generated reference power value to produce an error signal and using the error signal to regulate a heater associated with the micro-ring modulator to maintain a resonant wavelength of the micro-ring modulator.

### CROSS-REFERENCE TO RELATED APPLICATIONS

This application claims the benefit of U.S. Provisional Patent Application Serial No. 63/782,940, filed Apr. 3, 2025, which is incorporated by reference herein for all purposes.

### TECHNICAL FIELD

The disclosure relates generally to photonic communication systems, and more specifically to adaptive thermal control methods and systems for micro-ring modulators (MRMs) used in wavelength-division-multiplexed (WDM) photonic links.

### BACKGROUND

The present background section is intended to provide context only, and the disclosure of any concept in this section does not constitute an admission that said concept is prior art.

Micro-ring modulators are used in photonic links for modulating optical signals, filtering, and detection. The resonance characteristics of MRMs enable efficient conversion of electrical data signals into optical domain signals. However, the resonant wavelength of an MRM is susceptible to fabrication errors and thermal fluctuations, which can adversely affect device performance and signal integrity. Some thermal control schemes employ a fixed reference power to regulate the resonant wavelength via a feedback loop. These approaches may assume a constant data pattern, often with a 50% duty cycle, but can fail to maintain optimal optical modulation amplitude (OMA) when the data pattern varies, such as during long runs of zeros or ones. This can result in degraded signal-to-noise ratio, transient disturbances, and ambiguity at the receiver side.

### SUMMARY

In various embodiments, the systems and methods described herein include systems, methods, and apparatuses for adaptive thermal control for micro-ring modulator in photonic links. The concepts described herein are based on adaptive thermal control systems and methods for micro-ring modulators in photonic links, where the reference power for the thermal control loop may be dynamically adjusted in real time based on a data pattern of the modulation signal. This adaptive approach ensures that the optical modulation amplitude (OMA) is maintained at or relatively near an optimal level regardless of changes in the data pattern, thereby improving signal integrity and system reliability.

In some aspects, the techniques described herein relate to a method for adaptive thermal control of a micro-ring modulator in a photonic link, including: receiving a modulation data signal for driving the micro-ring modulator; generating a reference power value based on a duty cycle of the modulation data signal; sensing an average optical power at a drop port of the micro-ring modulator; comparing the sensed average optical power to the generated reference power value to produce an error signal; and using the error signal to regulate a heater associated with the micro-ring modulator to maintain a resonant wavelength of the micro-ring modulator.

In some aspects, the techniques described herein relate to a method, further including: synchronizing a timing of the generated reference power value with a timing of the sensed average optical power by introducing delay elements to compensate for associated propagation delays.

In some aspects, the techniques described herein relate to a method, wherein calculating the duty cycle includes applying a low-pass filter to the modulation data signal to obtain a time-averaged value representative of the duty cycle.

In some aspects, the techniques described herein relate to a method, wherein generating the reference power value is performed in a digital domain.

In some aspects, the techniques described herein relate to a method, wherein generating the reference power value is performed in an analog domain.

In some aspects, the techniques described herein relate to a method, wherein generating the reference power value is performed in a hybrid domain including analog and digital processing.

In some aspects, the techniques described herein relate to a method, wherein sensing the average optical power includes: converting optical power at the drop port to an electrical current using a photodiode; and converting the electrical current to a voltage using a transimpedance amplifier.

In some aspects, the techniques described herein relate to a method, wherein regulating the heater includes: adjusting a voltage applied to the heater in response to the error signal to shift the resonant wavelength of the micro-ring modulator.

In some aspects, the techniques described herein relate to a method, wherein the adaptive thermal control maintains an optical modulation amplitude at a maximum value regardless of changes in the modulation data signal or changes in environment.

In some aspects, the techniques described herein relate to a method, wherein the reference power value is determined from a formula based on a duty cycle D and average optical power values P0 and P1, P0 and P1 corresponding respectively to logical data values 0 and 1 of the modulation data signal.

In some aspects, the techniques described herein relate to a method, further including: calibrating the values of P0 and P1 based on measuring respectively the average optical power at the drop port for the logical data values 0 and 1 of the modulation data signal.

In some aspects, the techniques described herein relate to an apparatus for adaptive thermal control of a micro-ring modulator in a photonic link, including: a micro-ring modulator configured to receive a modulation data signal from a signal source; an adaptive thermal control unit to receive the modulation data signal from the signal source and generate a reference power value based on a duty cycle of the modulation data signal; a sensing circuit configured to sense an average optical power at a drop port of the micro-ring modulator; an adder to produce an error signal from the sensed average optical power and the reference power value; and a controller configured to use the error signal to regulate a heater associated with the micro-ring modulator, the controller maintaining a resonant wavelength of the micro-ring modulator based on using the error signal.

In some aspects, the techniques described herein relate to an apparatus, further including delay elements configured to synchronize a timing of the generated reference power value with a timing of the sensed average optical power to compensate for associated propagation delays.

In some aspects, the techniques described herein relate to an apparatus, wherein the apparatus includes a low-pass filter configured to process the modulation data signal to obtain a time-averaged value representative of the duty cycle.

In some aspects, the techniques described herein relate to an apparatus, wherein the reference power generator is implemented in a digital domain, an analog domain, or a hybrid domain including analog and digital processing.

In some aspects, the techniques described herein relate to an apparatus, wherein the sensing circuit includes a photodiode configured to convert optical power at the drop port to an electrical current and a transimpedance amplifier configured to convert the electrical current to a voltage.

In some aspects, the techniques described herein relate to an apparatus, wherein the controller is configured to adjust a voltage applied to the heater in response to the error signal, the controller shifting the resonant wavelength of the micro-ring modulator based on the voltage applied to the heater.

In some aspects, the techniques described herein relate to a non-transitory computer-readable medium storing instructions that, when executed by one or more processors of a control system, cause the control system to: receive a modulation data signal for driving a micro-ring modulator; generate a reference power value based on a duty cycle of the modulation data signal; sense an average optical power at a drop port of the micro-ring modulator; compare the sensed average optical power to the generated reference power value to produce an error signal; and use the error signal to regulate a heater associated with the micro-ring modulator to maintain a resonant wavelength of the micro-ring modulator.

In some aspects, the techniques described herein relate to a non-transitory computer-readable medium, wherein the instructions, when executed, further cause the control system to synchronize a timing of the generated reference power value with a timing of the sensed average optical power by introducing delay elements to compensate for associated propagation delays.

In some aspects, the techniques described herein relate to a non-transitory computer-readable medium, wherein generating the reference power value based on the duty cycle includes applying a low-pass filter to the modulation data signal to obtain a time-averaged value representative of the duty cycle.

A computer-readable medium is disclosed. The computer-readable medium can store instructions that, when executed by a computer, cause the computer to perform substantially the same or similar operations as described herein are further disclosed. Similarly, non-transitory computer-readable media, devices, and systems for performing substantially the same or similar operations as described herein are further disclosed.

The adaptive thermal control system described herein provides several advantages over fixed-reference schemes. For example, the systems and methods described herein maintain maximum OMA regardless of data pattern variations, improving receiver-side data discrimination. Also, transient disturbances during changes in data pattern are eliminated, enhancing signal stability. Additionally, the systems and methods described herein reduce power consumption by avoiding unnecessary heater activation. The systems and methods described herein provide implementation options for integration with various photonic and electronic platforms.

### BRIEF DESCRIPTION OF THE DRAWINGS

The above-mentioned aspects and other aspects of the present systems and methods will be better understood when the present application is read in view of the following figures in which like numbers indicate similar or identical elements. Further, the drawings provided herein are for purpose of illustrating certain embodiments only; other embodiments, which may not be explicitly illustrated, are not excluded from the scope of this disclosure.

These and other features and advantages of the present disclosure will be appreciated and understood with reference to the specification, claims, and appended drawings, wherein:

FIG. 1 illustrates an example system of a transmitter and receiver in accordance with one or more implementations as described herein.

FIG. 2 illustrates an example system of a photonic integrated circuit (PIC) in accordance with one or more implementations as described herein.

FIG. 3 illustrates an example system of an adaptive thermal control unit in accordance with one or more implementations as described herein.

FIG. 4 illustrates an example system of a digital control unit in accordance with one or more implementations as described herein.

FIG. 5 illustrates an example system of a hybrid analog/digital control unit in accordance with one or more implementations as described herein.

FIG. 6 illustrates an example system of an analog control unit in accordance with one or more implementations as described herein.

FIG. 7 depicts a flow diagram illustrating an example method associated with the disclosed systems, in accordance with example implementations described herein.

FIG. 8 depicts a flow diagram illustrating an example method associated with the disclosed systems, in accordance with example implementations described herein.

While the present systems and methods are susceptible to various modifications and alternative forms, specific embodiments thereof are shown by way of example in the drawings and will herein be described. The drawings may not be to scale. It should be understood, however, that the drawings and detailed description thereto are not intended to limit the present systems and methods to the particular form disclosed, but to the contrary, the intention is to cover all modifications, equivalents, and alternatives falling within the spirit and scope of the present systems and methods as defined by the appended claims.

### DETAILED DESCRIPTION OF VARIOUS EMBODIMENTS

The details of one or more embodiments of the subject matter described herein are set forth in the accompanying drawings and the description below. Other features, aspects, and advantages of the subject matter will become apparent from the description, the drawings, and the claims.

Various embodiments of the present disclosure are described with reference to the accompanying drawings, in which some, but not all embodiments are shown. Indeed, the disclosure may be embodied in many forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Like numbers refer to like elements throughout. Arrows in each of the figures depict bi-directional data flow and/or bi-directional data flow capabilities. The terms “path,” “pathway” and “route” are used interchangeably herein.

Embodiments of the present disclosure may be implemented in various ways, including as computer program products that comprise articles of manufacture. A computer program product may include a non-transitory computer-readable storage medium storing applications, programs, program components, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media includes all computer-readable media (including volatile and non-volatile media).

In one embodiment, a non-volatile computer-readable storage medium may include a floppy disk, flexible disk, hard disk, solid-state storage (SSS) (for example a solid-state drive (SSD)), solid state card (SSC), solid state module (SSM), enterprise flash drive, magnetic tape, or any other non-transitory magnetic medium, and/or the like. A non-volatile computer-readable storage medium may include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may include read-only memory (ROM), programmable read-only memory (PROM), erasable programmable read-only memory (EPROM), electrically erasable programmable read-only memory (EEPROM), flash memory (for example Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may include conductive-bridging random-access memory (CBRAM), phase-change random-access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random-access memory (FJG RAM), Millipede memory, racetrack memory, and/or the like.

In one embodiment, a volatile computer-readable storage medium may include random-access memory (RAM), dynamic random-access memory (DRAM), static random-access memory (SRAM), fast page mode dynamic random-access memory (FPM DRAM), extended data-out dynamic random-access memory (EDO DRAM), synchronous dynamic random-access memory (SDRAM), double data rate synchronous dynamic random-access memory (DDR SDRAM), double data rate type two synchronous dynamic random-access memory (DDR2 SDRAM), double data rate type three synchronous dynamic random-access memory (DDR3 SDRAM), Rambus dynamic random-access memory (RDRAM), Twin Transistor RAM (TTRAM), Thyristor RAM (T-RAM), Zero-capacitor (Z-RAM), Rambus in-line memory component (RIMM), dual in-line memory component (DIMM), single in-line memory component (SIMM), video random-access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of a hardware embodiment, a computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, a hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially, such that one instruction is retrieved, loaded, and executed at a time. In some examples, retrieval, loading, and/or execution may be performed in parallel, such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not be necessarily all referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms, and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms, and a plural term may include the corresponding singular form. It is further noted that various figures(including component diagrams) shown and discussed herein are for illustrative purpose only, and are not drawn to scale. Similarly, various waveforms and timing diagrams are shown for illustrative purpose only. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some embodiments and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly referenced parts/modules are the only way to implement some of the embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software instructions stored on non-transitory media, software executed by a processor, firmware, and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on chip (SoC), an assembly, and so forth.

The provided description is presented to enable one of ordinary skill in the art to make and use the subject matter disclosed herein and to incorporate it in the context of particular applications. While the following is directed to specific examples, other and further examples may be devised without departing from the basic scope thereof.

Various modifications, as well as a variety of uses in different applications, will be readily apparent to those skilled in the art, and the general principles defined herein may be applied to a wide range of embodiments. Thus, the subject matter disclosed herein is not intended to be limited to the embodiments presented, but is to be accorded the widest scope consistent with the principles and novel features disclosed herein.

In the description provided, numerous specific details are set forth in order to provide a more thorough understanding of the subject matter disclosed herein. It will, however, be apparent to one skilled in the art that the subject matter disclosed herein may be practiced without necessarily being limited to these specific details. In other instances, well-known structures and devices are shown in block diagram form, rather than in detail, in order to avoid obscuring the subject matter disclosed herein.

All the features disclosed in this specification (e.g., any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Various features are described herein with reference to the figures. It should be noted that the figures are only intended to facilitate the description of the features. The various features described are not intended as an exhaustive description of the subject matter disclosed herein or as a limitation on the scope of the subject matter disclosed herein. Additionally, an illustrated example need not have all the aspects or advantages shown. An aspect or an advantage described in conjunction with a particular example is not necessarily limited to that example and can be practiced in any other examples even if not so illustrated, or if not so explicitly described.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

It is noted that, if used, the labels left, right, front, back, top, bottom, forward, reverse, clockwise and counterclockwise have been used for convenience purposes only and are not intended to imply any particular fixed direction. Instead, the labels are used to reflect relative locations and/or directions between various portions of an object.

Data processing may include data buffering, aligning incoming data from multiple communication lanes, forward error correction (FEC), etc. For example, data may be received by an analog front end (AFE), which can prepare the incoming data for digital processing. The digital portion of the transceivers (e.g., digital signal processor (DSP)) may provide skew management, equalization, reflection cancellation, and/or other functions. It is to be appreciated that the process described herein can provide many benefits, including saving both power and cost.

Moreover, the terms “system,” “component,” “module,” “interface,” “model,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution, and a component may be localized on one computer and/or distributed between two or more computers.

Unless explicitly stated otherwise, each numerical value and range may be interpreted as being approximate, as if the word “about” or “approximately” preceded the value of the value or range. Signals and corresponding nodes or ports might be referred to by the same name and are interchangeable for purposes here.

While embodiments may have been described with respect to circuit functions, the embodiments of the subject matter disclosed herein are not limited. Possible implementations may be embodied in a single integrated circuit, a multi-chip module, a single card, SoC, or a multi-card circuit pack. As would be apparent to one skilled in the art, the various embodiments might also be implemented as part of a larger system. Such embodiments may be employed in conjunction with, for example, a digital signal processor, microcontroller, field-programmable gate array, application-specific integrated circuit, or general-purpose computer.

As would be apparent to one skilled in the art, various functions of circuit elements may also be implemented as processing blocks in a software program. Such software may be employed in, for example, a digital signal processor, microcontroller, or general-purpose computer. Such software may be embodied in the form of program code embodied in tangible media, such as magnetic recording media, optical recording media, solid-state memory, floppy diskettes, CD-ROMs, hard drives, or any other non-transitory machine-readable storage medium, that when the program code is loaded into and executed by a machine, such as a computer, the machine becomes an apparatus for practicing the subject matter disclosed herein. When implemented on a general-purpose processor, the program code segments combine with the processor to provide a unique device that operates analogously to specific logic circuits. Described embodiments may also be manifest in the form of a bit stream or other sequence of signal values electrically or optically transmitted through a medium, stored magnetic-field variations in a magnetic recording medium, etc., generated using a method and/or an apparatus as described herein.

Some thermal control techniques for micro-ring modulators and micro-ring filters can rely on maintaining a fixed reference power in the feedback loop, which is calibrated under the assumption of a constant data pattern, often with an equal distribution of zeros and ones. Such approaches can fail to account for real-time variations in the modulation data pattern, such as long runs of identical bits or abrupt changes in duty cycle, resulting in suboptimal optical modulation amplitude (OMA), degraded signal-to-noise ratio, and increased ambiguity between logical 0 and logical 1 levels of a data signal. Furthermore, such systems can be prone to transient disturbances and relatively slow response when the data pattern shifts, leading to unreliable data discrimination and reduced overall system performance. In contrast, the adaptive thermal control concepts described herein can dynamically adjust the reference power based on the actual data pattern, maintain optimal OMA, and synchronize control actions with sensed optical power, thereby overcoming the limitations of conventional techniques and ensuring robust, high-fidelity photonic communication.

The adaptive thermal control concepts described herein provide a solution to fixed reference power systems by continuously monitoring the real-time data pattern of a modulation signal and dynamically generating a reference power that reflects the current, real-time duty cycle, rather than relying on a static reference. This adaptive reference power may be calculated using calibrated optical power values for both data states and can be synchronized with the sensed average optical power through synchronization elements (e.g., time delay elements, time advance elements), ensuring precise temporal alignment. By feeding this data-pattern-dependent reference into the thermal control loop, the system maintains the resonant wavelength of micro-ring modulators and micro-ring filters at the optimal position for maximum optical modulation amplitude (OMA), regardless of data pattern variations. The adaptive thermal control approach described herein eliminates transient disturbances, enhances signal integrity, and enables reliable data discrimination at the receiver, thereby substantially improving the performance and robustness of photonic communication systems.

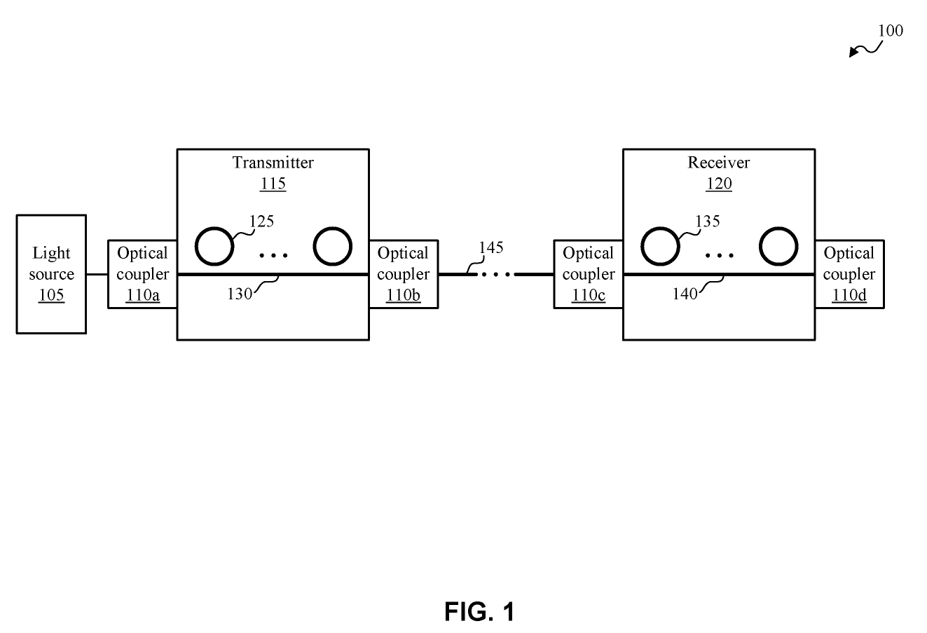

FIG. 1 illustrates an example system 100 of a transmitter and receiver in accordance with one or more implementations as described herein. In FIG. 1, system 100 may include light source 105, one or more optical couplers (e.g., optical coupler 110a, optical coupler 110b, optical coupler 110c, optical coupler 110d), transmitter 115, and receiver 120. As shown, transmitter 115 may include one or more micro-ring modulators (MRMs), such as MRM 125 relative to waveguide 130. As shown, receiver 120 may include one or more micro-ring filters, such as micro-ring filter 135 relative to waveguide 140. As shown, receiver 120 may connect to transmitter 115 via interface 145.

System 100 may implement wavelength-division multiplexing (WDM), which allows multiple optical signals at different wavelengths to be transmitted simultaneously over a single optical fiber. System 100 may be implemented in conjunction with optical components such as waveguides, modulators, detectors, and multiplexers on a silicon substrate. The adaptive thermal control systems can be implemented within silicon photonics platforms to provide robust and scalable solutions for high-speed optical interconnects.

Light source 105 may include a tunable or fixed-wavelength light source configured to generate a coherent optical signal for transmission through a photonic link. Light source 105 may include a laser or light-emitting diode (LED). In some cases, light source 105 may include a multi-wavelength light source (e.g., multi-wavelength laser, multi-wavelength LED). Light source 105 may be coupled to an input of transmitter 115 via optical coupler 110a, enabling efficient injection of an optical carrier onto waveguide 130. Light source 105 may be configured to support multiple wavelengths for wavelength-division multiplexing (WDM) applications.

Transmitter 115 may be configured to take an electrical input signal and convert it into an optical signal using light from light source 105 to send the optical signal through waveguide 130 and interface 145. Transmitter 115 may modulate the light (e.g., by turning it on and off rapidly) to encode the data, which transmitter 115 may transmit from waveguide 130 to interface 145 for transmission (e.g., long-distance transmission) to receiver 120.

Transmitter 115 may use micro-ring modulators (e.g., MRM 125) to multiplex wavelengths of light from an electrical data signal. MRM 125 in transmitter 115 may be configured to encode electrical data signals onto an optical carrier (e.g., waveguide 130). MRM 125 may include a ring-shaped waveguide integrated on a semiconductor (e.g. silicon) photonics substrate. As shown, MRM 125 may be positioned adjacent to and relatively near waveguide 130. Waveguide 130 may carry input laser light from light source 105. Waveguide 130 and waveguide 140 may include an integrated semiconductor waveguide (e.g., silicon waveguide) and/or one or more fiber optic cables.

By applying a modulation voltage corresponding to a data signal, the refractive index of MRM 125 is altered, causing its resonant wavelength to shift and modulate the intensity of the transmitted or dropped optical signal, which enables high-speed conversion of digital data into optical pulses, which are then transmitted through the photonic link. In systems utilizing adaptive thermal control, the micro-ring modulator’s resonant wavelength may be actively regulated to maintain optimal optical modulation amplitude (OMA), ensuring reliable and efficient data transmission even in the presence of fabrication variations and thermal fluctuations.

Interface 145 may include an optical interface that connects transmitter 115 to receiver 120. As shown, interface 145 may connect to transmitter 115 via optical coupler 110b, and connect to receiver 120 via optical coupler 110c. Interface 145 may include an integrated semiconductor waveguide (e.g., silicon waveguide) and/or one or more fiber optic cables.

Receiver 120 may receive an optical signal from transmitter 115 via interface 145. Receiver 120 may convert the optical signal back into an electrical signal. Receiver 120 may detect the incoming light (e.g., via one or more photodetectors of receiver 120), convert the light to an electrical signal, and process the electrical signal, which can be for high-bandwidth communications, sensitive measurements, or systems operating in environments with high electromagnetic interference. In some cases, each micro-ring filter of receiver 120 may include at least one photodetector.

Receiver 120 may use micro-ring filters (e.g., micro-ring filter 135) to demultiplex wavelengths of received light. Micro-ring filter 135 may include receiver circuitry, which may include a photodiode and optical receiver chip (e.g., CMOS optical receiver chip). Micro-ring filters of receiver 120 may be configured to separate and route specific wavelengths of light, acting as selective, tunable optical filters. Micro-ring filters, such as micro-ring filter 135, may use the resonant behavior of light in a small ring-shaped waveguide. When an optical signal's wavelength matches the micro-ring’s resonant wavelength, the light may be directed to a drop port of receiver 120, while other wavelengths continue along the main through port (e.g., waveguide 140). Thus, micro-ring modulators of transmitter 115 and micro-ring filters of receiver 120 may be configured, respectively, as multiplexers / demultiplexers in optical communication systems. In some cases, a first micro-ring filter of receiver 120 (e.g., micro-ring filter 135) may be tuned to a first wavelength, a second micro-ring filter of receiver 120 may be tuned to a second wavelength, and so on.

Adaptive thermal control systems such as system 100 can be used in conjunction with a wide range of related technologies, including silicon photonics, WDM, integrated photodiodes, transimpedance amplifiers (TIAs), digital-signal-processors (DSPs), temperature sensors, optical transceivers, error correction units, hybrid digital/analog electronic systems, and machine learning.

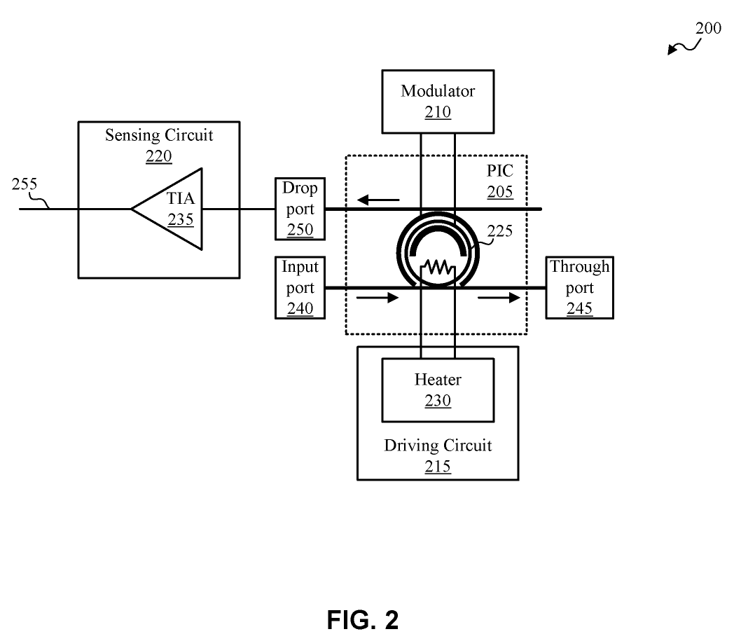

FIG. 2 illustrates an example system 200 of a photonic integrated circuit (PIC) in accordance with one or more implementations as described herein. System 200 may be configured for adaptive thermal control in a photonic communication environment. In some configurations, one or more aspects of system 200 may be implemented by or in conjunction with system 100, one or more components of system 100, or any combination thereof.

In the illustrated example, system 200 may include photonic integrated circuit (PIC) 205, modulator 210, driving circuit 215, and sensing circuit 220. As shown, PIC 205 may include micro-ring 225, which may be an example of MRM 125 or micro-ring filter 135. As shown, driving circuit 215 may include heater 230, and sensing circuit 220 may include transimpedance amplifier (TIA) 235. In the illustrated example, system 200 may include input port 240, through port 245, and drop port 250.

Modulator 210 may drive a data signal (e.g., via a modulation data signal driver). As shown, modulator 210 may be communicatively coupled to micro-ring 225. Thus, modulator 210 may drive a data signal, such as through a modulation data signal driver, and being communicatively coupled to the micro-ring 225, may facilitate high-speed modulation of optical signals. As shown, PIC 205 may receive an optical signal via input port 240. Micro-ring 225 may be resonant to a wavelength of light included in the optical signal. The resonant wavelength may resonate through micro-ring 225. Other non-resonant wavelengths included in the optical signal may through and out of PIC 205 via through port 245. In some cases, the optical signal may travel from through port 245 to another micro-ring of system 200.

As shown, driving circuit 215 includes heater 230, which may enable precise thermal tuning of the wavelength characteristics of micro-ring 225. Driving circuit 215 may include electronic driving circuitry configured to power and control components within system 200, heater 230 integrated in driving circuit 215. The driving circuitry can power or generate signals for modulation via modulator 210. For instance, driving circuit 215 may generate electrical signals for modulator 210. Driving circuit 215 may provide electrical signals used to actively stabilize the resonance wavelength of micro-ring 225 against temperature fluctuations. A controller of PIC 205 may compare a state of modulator 210 against a reference and send the appropriate signal to heater 230 to make adjustments. By adjusting a temperature of heater 230, driving circuit 215 can precisely change the refractive index of micro-ring 225, which in turn shifts the resonant wavelength of micro-ring 225.

Sensing circuit 220 may be configured to monitor the optical output of drop port 250. Drop port 250 may channel a portion of the optical signal from PIC 205 to sensing circuit 220 for feedback and control purposes. In some cases, photocurrent may be generated based on the wavelength of light resonating in micro-ring 225. In some cases, this photocurrent may be generated by a photodetector of PIC 205. The photocurrent may exit PIC 205 and may be received by sensing circuit 220 via drop port 250. As shown, sensing circuit 220 includes TIA 235. In some cases, TIA 235 may be a low-bandwidth (LBW) transimpedance amplifier.

TIA 235 may be configured to convert the photocurrent (e.g., amplify the relatively small current of the photocurrent) into a usable voltage signal (e.g., measured average power 255). Measured average power 255 may represent a measured drop port average power. In some cases, data may be deciphered from the measured average power 255 output by TIA 235.

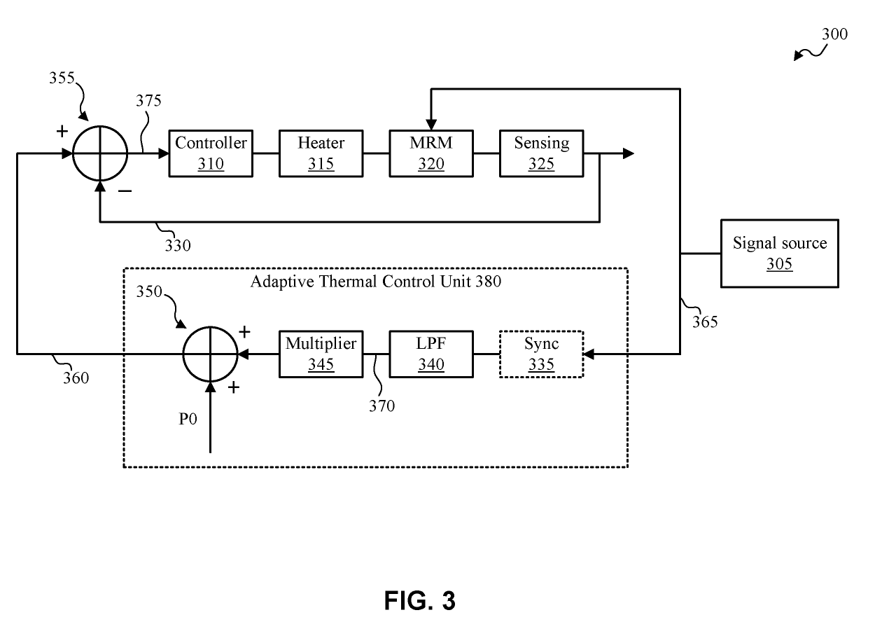

FIG. 3 illustrates an example system 300 of an adaptive thermal control unit in accordance with one or more implementations as described herein. System 300 may be configured for adaptive thermal control in a photonic communication environment. In some configurations, one or more aspects of system 300 may be implemented by or in conjunction with system 100, system 200, one or more components of system 100 and/or system 200, or any combination thereof.

In the illustrated example, system 300 may include signal source 305, controller 310, heater 315, micro-ring modulator (MRM) 320, and sensing 325. MRM 320 may be an example of micro-ring 225, heater 315 may be an example of heater 230, sensing 325 may be an example of sensing circuit 220, and signal 330 may be an example of measured average power 255. Although system 300 depicts a micro-ring modulator, the methods of system 300 may be applicable to a micro-ring filter or a micro-ring modulator.

In some cases, sensing 325 may generate signal 330, where signal 330 may represent a measured drop port average power. As shown, system 300 may also include sync 335, low-pass filter (LPF) 340, multiplier 345, adder 350, and adder 355. In some cases, sync 335 may be an optional component of system 300. As shown, sync 335, LPF 340, multiplier 345, and adder 350 may be referred to as components of adaptive thermal control unit 380 of system 300. Adder 350 may output signal 360. Signal 360 may represent a reference power value generated from the components of adaptive thermal control unit 380.

Controller 310 may be configured to control one or more aspects of heater 315. Controller 310 may be an example of driving circuit 215. Heater 315 may be an example of heater 230. Controller 310 may adjust an amount of voltage applied to heater 315 to control an amount of heat that heater 315 applies to MRM 320. The amount of voltage that controller 310 applies to heater 315 may be based on an output of sensing 325. As shown, an output of sensing 325 loops back to controller 310 via adder 355.

Sensing 325 may be an example of sensing circuit 220. Sensing 325 may measure a drop port average power of MRM 320. Thus, as shown, sensing 325 outputs drop port average power of signal 330, which may be provided to adder 355. As shown, drop port average power of signal 330 may be provided to another component of system 300.

As shown, signal source 305 may provide data signal 365 to MRM 320 and provide the same data signal 365 to adaptive thermal control unit 380 (e.g., to sync 335, LPF 340, multiplier 345, adder 350). Data signal 365 from signal source 305 may be a modulated data signal (e.g., voltage signal varying between a logical zero voltage and logical one voltage).

Sync 335 may synchronize data signal 365 (e.g., delay data signal 365, advance data signal 365, etc.) to ensure that signal 360 is synchronized with signal 330. For example, sync 335 may add a delay to data signal 365 or advance data signal 365 so that the time it takes data signal 365 to travel through sync 335, LPF 340, multiplier 345, adder 350 and arrive at adder 355 (e.g., as signal 360) matches the time it takes data signal 365 to pass through MRM 320, sensing 325, and arrive at adder 355 (e.g., as signal 330). Accordingly, sync 335 may include synchronization elements that ensure the calculated reference power of signal 360 is synchronized with the measured dropout optical power of signal 330. In some cases, data signal 365 may be provided to LPF 340 based on system 300 not implementing sync 335.

As shown, LPF 340 may receive a delayed version (e.g., or advanced version) of data signal 365. Alternatively, LPF 340 may be receive data signal 365 from signal source 305. LPF 340 may output duty cycle 370 (e.g., an equivalent of the duty cycle) of data signal 365 (e.g., of the delayed/advanced data signal 365). In some cases, LPF 340 may generate a time-averaged value representative of the duty cycle of the modulation data signal.

Multiplier 345 may multiply duty cycle 370 by some value. In some cases, multiplier 345 may multiply duty cycle 370 by the difference of average optical power values P0 and P1 (e.g., P1 – P0), where P0 and P1 correspond respectively to logical data values 0 and 1 of data signal 365. As shown, adder 350 may sum P0 with a product of duty cycle 370 and the difference of P1 and P0 output by multiplier 345. Thus, the reference power value of signal 360 may be determined from a formula based on a sum of P0 and the product of a duty cycle D and average optical power values P0 and P1. When duty cycle 370 is all logical ones, P1 is being regulated by system 300. When duty cycle 370 is all logical zeros, P0 is being regulated by system 300.

As shown, adder 355 may add signal 360 to a negative instance of signal 330. For example, adder 355 may subtract signal 330 from signal 360. The result of adder subtracting signal 330 from signal 360 may be error signal 375. As shown, controller 310 may receive error signal 375. Controller 310 may use error signal 375 to regulate heater 315 to maintain a resonant wavelength of MRM 320.

Accordingly, system 300 is configured to maintain an optimal optical modulation amplitude (OMA) regardless of data pattern variations, which improves receiver-side data discrimination (e.g., deciphering logical 1s from logical 0s). Also, based on the described adaptive thermal control aspects, system 300 eliminates transient disturbances during changes in data pattern, enhancing signal stability. Additionally, based on the described adaptive thermal control aspects, system 300 reduces power consumption by avoiding unnecessary activation of heater 315.

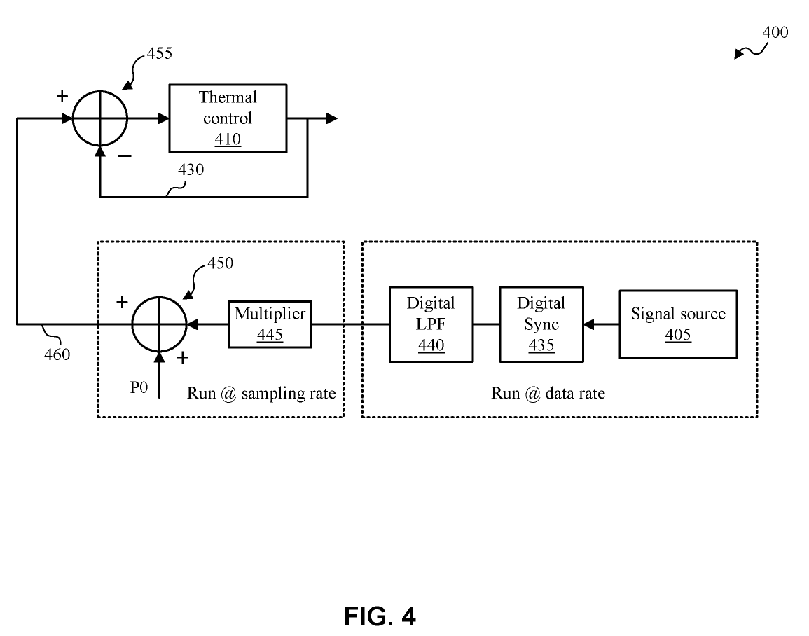

FIG. 4 illustrates an example system 400 of a digital control unit in accordance with one or more implementations as described herein. System 400 may be configured for adaptive thermal control in a photonic communication environment. In some configurations, one or more aspects of system 400 may be implemented by or in conjunction with system 100, system 200, system 300, one or more components of at least one of these systems, or any combination thereof. Adaptive thermal control unit 380 (e.g., sync 335, LPF 340, multiplier 345, and adder 350) can be implemented in the digital domain, analog domain, or hybrid domain. System 400 depicts adaptive thermal control unit 380 implemented in digital domain.

In the illustrated example, system 400 may include signal source 405, thermal control 410, digital sync 435, digital LPF 440, multiplier 445, adder 450, and adder 455. One or more components of system 400 may be implementations of corresponding components of system 300. For example, thermal control 410 (e.g., a thermal control loop) may include and/or perform any of the operations of controller 310, heater 315, MRM 320, and/or sensing 325. Digital sync 435 may be an example of sync 335, digital LPF 440 may be an example of LPF 340, and multiplier 445 may be an example of multiplier 345, etc. Digital sync 435 may include digital synchronization elements (e.g., digital-based circuitry). Similarly, digital LPF 440 may include digital LPF elements (e.g., digital-based circuitry).

Signal source 405 may generate a digital data signal (e.g., digital modulated data signal). Digital sync 435 may delay the digital data signal and provide the delayed digital data signal to digital LPF 440. In some cases, signal source 405, digital sync 435, and/or digital LPF 440 may run at data rate, while multiplier 445 and/or adder 450 may run at a sampling rate.

The data rate can refer to the speed at which data bits are transmitted or processed in system 400, which may be measured in bits per second (bps). In some cases, the data rate may be the rate at which an electrical data signal is modulated onto an optical carrier (e.g., by signal source 405) and sent through a communication channel of system 400. The sampling rate may be the frequency at which an analog signal (such as the sensed optical power or the output of a photodiode) is measured and converted into digital values, which may be done by an analog-to-digital converter (ADC). The sampling rate may be measured in samples per second, and may determine how often system 400 takes a measurement of a signal for processing or feedback control. Accordingly, the data rate can define the speed of data transmission, while the sampling rate can define how often the system measures or processes signals for control or monitoring purposes.

Digital LPF 440 may generate a duty cycle of the delayed digital data signal to multiplier 445. Multiplier 445 may generate a product of the digital duty cycle and a difference of P1 and P0. As shown, adder 450 may sum P0 with the product from multiplier 445. Signal 460 may be based on the sum produced by adder 450. Based on the digital components of system 400, signal 460 may be a digital signal.

In some cases, signal 430 may include a digital signal based on an analog-to-digital (ADC) conversion of the drop port power generated by thermal control 410 (e.g., generated by a sensing element of thermal control 410 similar to sensing 325). In some cases, thermal control 410 (e.g., a sensing element of thermal control 410) may include ADC circuitry to convert the drop port power from analog to digital.

In some examples, signal 430 and signal 460 may be digital signals based on the digital components of system 400. Thus, adder 455 may add the two digital signals and provide a resulting digital signal to thermal control 410. The resulting digital signal may be a digital error signal. Thermal control 410 (e.g., a controller of thermal control 410 similar to controller 310) may receive the digital error signal from adder 455 and use the digital error signal to regulate a heater of thermal control 410 to maintain a resonant wavelength of a micro-ring component of thermal control 410.

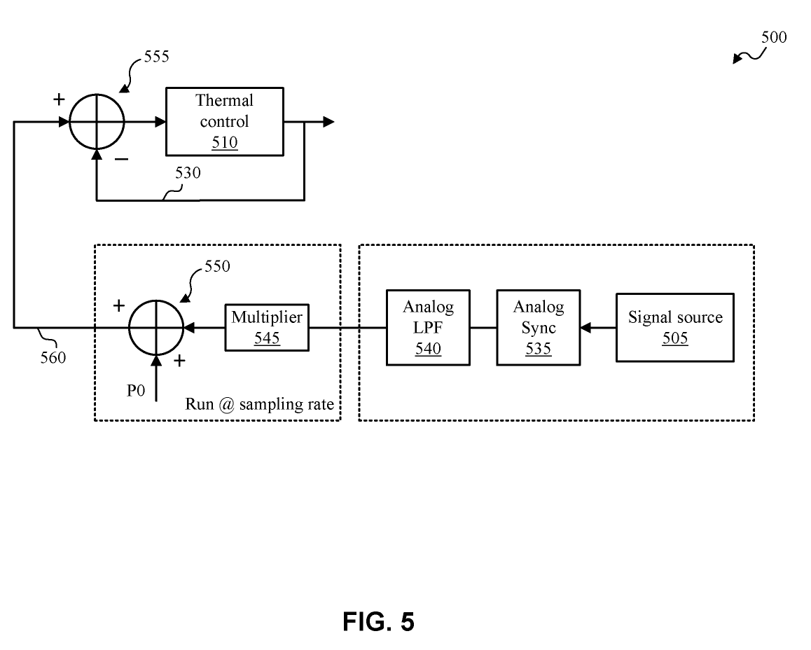

FIG. 5 illustrates an example system 500 of a hybrid analog/digital control unit in accordance with one or more implementations as described herein. System 500 may be configured for adaptive thermal control in a photonic communication environment. In some configurations, one or more aspects of system 500 may be implemented by or in conjunction with system 100, system 200, system 300, system 400, one or more components of at least one of these systems, or any combination thereof. Adaptive thermal control unit 380 (e.g., sync 335, LPF 340, multiplier 345, and adder 350) can be implemented in the digital domain, analog domain, or hybrid domain. System 500 depicts adaptive thermal control unit 380 implemented in the hybrid analog/digital domain.

In the illustrated example, system 500 may include signal source 505, thermal control 510, analog sync 535, analog LPF 540, multiplier 545, adder 550, and adder 555. One or more components of system 500 may be implementations of corresponding components of system 300. For example, thermal control 510 (e.g., a thermal control loop) may include and/or perform any of the operations of controller 310, heater 315, MRM 320, and/or sensing 325. Analog sync 535 may be an example of sync 335, analog LPF 540 may be an example of LPF 340, and multiplier 545 may be an example of multiplier 345, etc. Analog sync 535 may include analog synchronization elements (e.g., analog-based circuitry). Similarly, analog LPF 540 may include analog LPF elements (e.g., analog-based circuitry).

Signal source 505 may generate an analog data signal (e.g., analog modulated data signal). Analog sync 535 may delay (e.g., or advance) the analog data signal and provide the delayed analog data signal to analog LPF 540. Analog LPF 540 may generate a duty cycle of the delayed analog data signal to multiplier 545.

In some cases, multiplier 545 and adder 550 may operate in the digital domain, while signal source 505, analog sync 535, and analog LPF 540 operate in the analog domain. In some cases, multiplier 545 may include an analog-to-digital converter (ADC). Alternatively, system 500 may include an ADC between analog LPF 540 and multiplier 545.

As shown, multiplier 545 and/or adder 550 may operate at a sampling rate of system 500. Multiplier 545 may generate a product of the duty cycle and a difference of P1 and P0, where the product is in the digital domain. As shown, adder 550 may sum P0 with the product from multiplier 545. Signal 560 may be based on the sum produced by adder 550. Based on the analog-to-digital conversion components of system 500, signal 560 may be a digital signal.

In some cases, signal 530 may include a digital signal based on an analog-to-digital (ADC) conversion of the drop port power generated by thermal control 510 (e.g., generated by a sensing element of thermal control 510 similar to sensing 325). In some cases, thermal control 510 (e.g., a sensing element of thermal control 510) may include ADC circuitry to convert the drop port power from analog to digital.

In some examples, signal 530 and signal 560 may be digital signals based on the ADC components of system 500. Thus, adder 555 may add the two digital signals and provide a resulting digital signal to thermal control 510. The resulting digital signal may be a digital error signal. Thermal control 510 (e.g., a controller of thermal control 510 similar to controller 310) may receive the digital error signal from adder 555 and use the digital error signal to regulate a heater of thermal control 510 to maintain a resonant wavelength of a micro-ring component of thermal control 510.

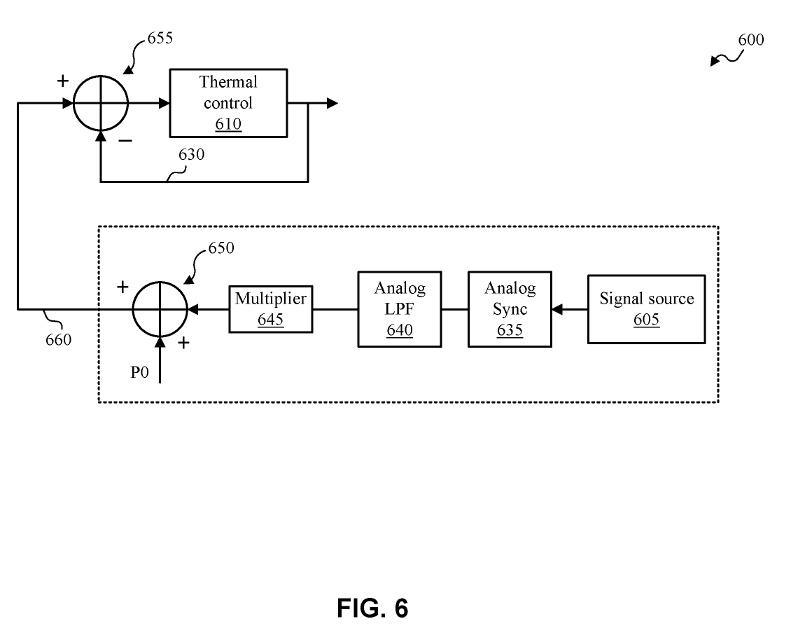

FIG. 6 illustrates an example system 600 of an analog control unit in accordance with one or more implementations as described herein. System 600 may be configured for adaptive thermal control in a photonic communication environment. In some configurations, one or more aspects of system 600 may be implemented by or in conjunction with system 100, system 200, system 300, system 400, system 500, one or more components of at least one of these systems, or any combination thereof. Adaptive thermal control unit 380 (e.g., sync 335, LPF 340, multiplier 345, and adder 350) can be implemented in the digital domain, analog domain, or hybrid domain. System 600 depicts adaptive thermal control unit 380 implemented in the analog domain.

In the illustrated example, system 600 may include signal source 605, thermal control 610, analog sync 635, analog LPF 640, multiplier 645, adder 650, and adder 655. One or more components of system 600 may be implementations of corresponding components of system 300. For example, thermal control 610 (e.g., a thermal control loop) may include and/or perform any of the operations of controller 310, heater 315, MRM 320, and/or sensing 325. Analog sync 635 may be an example of sync 335, analog LPF 640 may be an example of LPF 340, and multiplier 645 may be an example of multiplier 345, etc. Analog sync 635 may include analog synchronization elements (e.g., analog-based circuitry). Similarly, analog LPF 640 may include analog LPF elements (e.g., analog-based circuitry).

Signal source 605 may generate an analog data signal (e.g., analog modulated data signal). Analog sync 635 may delay (e.g., or advance) the analog data signal and provide the delayed analog data signal to analog LPF 640. Analog LPF 640 may generate a duty cycle of the analog data signal to multiplier 645. Multiplier 645 may generate a product of the analog duty cycle and a difference of P1 and P0. As shown, adder 650 may sum P0 with the product from multiplier 645. Signal 660 may be based on the sum produced by adder 650. Based on the analog components of system 600, signal 660 may be an analog signal.

In some examples, signal 630 and signal 660 may be analog signals based on the analog components of system 600. Thus, adder 655 may add the two analog signals and provide a resulting analog signal to thermal control 610. The resulting analog signal may be an analog error signal. Thermal control 610 (e.g., a controller of thermal control 610 similar to controller 310) may receive the analog error signal from adder 655 and use the analog error signal to regulate a heater of thermal control 610 to maintain a resonant wavelength of a micro-ring component of thermal control 610.

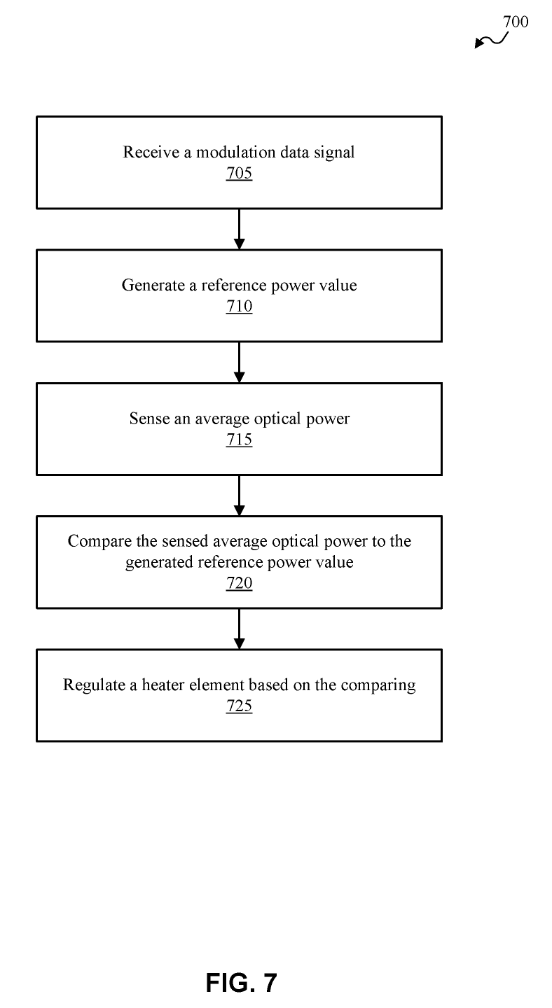

FIG. 7 depicts a flow diagram illustrating an example method 700 associated with the disclosed systems, in accordance with example implementations described herein. In some configurations, one or more aspects of method 700 may be implemented by or in conjunction with system 100, system 200, system 300, system 400, system 500, one or more components of at least one of these systems, or any combination thereof. The depicted method 700 is just one implementation, and one or more operations of method 700 may be rearranged, reordered, omitted, and/or otherwise modified such that other implementations are possible and contemplated.

At 705, method 700 may include receiving a modulation data signal. For example, a resonant micro-ring (e.g., MRM 125, micro-ring filter 135) and an adaptive thermal control component (e.g., sync 335, LPF 340) may receive the modulation data signal.

At 710, method 700 may include generating a reference power value. For example, an adaptive thermal control component (e.g., adder 350) may generate a reference power value (e.g., signal 360) based on a duty cycle of the modulation data signal.

At 715, method 700 may include sensing an average optical power. For example, sensing circuit 220 or sensing 325 may sense an average optical power at a drop port of a micro-ring modulator or micro-ring filter.

At 720, method 700 may include comparing the sensed average optical power to the generated reference power value. For example, adder 355 and/or controller 310 may compare the sensed average optical power to the generated reference power value to produce an error signal (e.g., error signal 375).

At 725, method 700 may include regulating a heater element based on the comparing. For example, controller 310 may use the error signal to regulate heater 315 to maintain a resonant wavelength of MRM 320 (e.g., or a micro-ring filter).

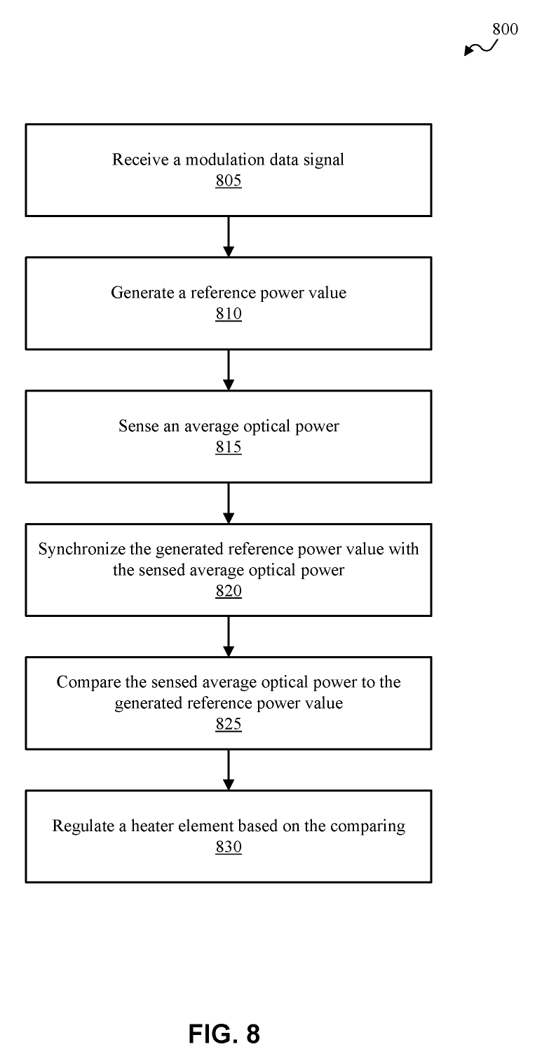

FIG. 8 depicts a flow diagram illustrating an example method 800 associated with the disclosed systems, in accordance with example implementations described herein. In some configurations, one or more aspects of method 800 may be implemented by or in conjunction with system 100, system 200, system 300, system 400, system 500, one or more components of at least one of these systems, or any combination thereof. The depicted method 800 is just one implementation, and one or more operations of method 800 may be rearranged, reordered, omitted, and/or otherwise modified such that other implementations are possible and contemplated.

At 805, method 800 may include receiving a modulation data signal. For example, a resonant micro-ring (e.g., MRM 125, micro-ring filter 135) and an adaptive thermal control component (e.g., sync 335, LPF 340) may receive the modulation data signal.

At 810, method 800 may include generating a reference power value. For example, an adaptive thermal control component (e.g., adder 350) may generate a reference power value (e.g., signal 360) based on a duty cycle of the modulation data signal.

At 815, method 800 may include sensing an average optical power. For example, sensing circuit 220 or sensing 325 may sense an average optical power at a drop port of a micro-ring modulator or micro-ring filter.

At 820, method 800 may include synchronizing the generated reference power value with the sensed average optical power. For example, sync 335 may synchronize a timing of the generated reference power value with a timing of the sensed average optical power by introducing synchronization elements to compensate for associated propagation delays.

At 825, method 800 may include comparing the sensed average optical power to the generated reference power value. For example, adder 355 and/or controller 310 may compare the sensed average optical power to the generated reference power value to produce an error signal (e.g., error signal 375).

At 830, method 800 may include regulating a heater element based on the comparing. For example, controller 310 may use the error signal to regulate heater 315 to maintain a resonant wavelength of MRM 320 (e.g., or a micro-ring filter).

In the examples described herein, the configurations and operations are example configurations and operations, and may involve various additional configurations and operations not explicitly illustrated. In some examples, one or more aspects of the illustrated configurations and/or operations may be omitted. In some embodiments, one or more of the operations may be performed by components other than those illustrated herein. Additionally, or alternatively, the sequential and/or temporal order of the operations may be varied.

Certain embodiments may be implemented in one or a combination of hardware, firmware, software stored on tangible media, and software executed by a processor. Other embodiments may be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

The word “exemplary” is used herein to mean “serving as an example, instance, or illustration.” Any embodiment described herein as “exemplary” is not necessarily to be construed as preferred or advantageous over other embodiments. Devices described herein may be wireless, wired, mobile, and/or stationary.

As used within this document, the term “communicate” is intended to include transmitting, or receiving, or both transmitting and receiving. Similarly, the bidirectional exchange of data between two devices (both devices transmit and receive during the exchange) may be described as ‘communicating’, when only the functionality of one of those devices is being claimed. The term “communicating” as used herein with respect to wired and/or wireless communication signals includes transmitting the wired and/or wireless communication signals and/or receiving the wired and/or wireless communication signals. For example, a communication unit, which is capable of communicating wired and/or wireless communication signals, may include a wired/wireless transmitter to transmit communication signals to at least one other communication unit, and/or a wired/wireless communication receiver to receive the communication signal from at least one other communication unit.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infrared (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth^{TM}, Global Positioning System (GPS), Wi-Fi, Wi-Max, ZigBee^{TM}, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Although an example processing system has been described above, embodiments of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more components of computer program instructions, encoded on computer storage medium for execution by, or to control the operation of, information/data processing apparatus. Alternatively, or in addition, the program instructions can be encoded on an artificially-generated propagated signal, for example, a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (for example multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example, an FPGA or an ASIC. The apparatus can also include, in addition to hardware, code that creates an execution environment for the computer program in question, for example code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a component, component, subroutine, object, or other unit suitable for use in a computing environment. A computer program may, but need not, correspond to a file in a file system. A program can be stored in a portion of a file that holds other programs or information/data (for example one or more scripts stored in a markup language document), in a single file dedicated to the program in question, or in multiple coordinated files (for example files that store one or more components, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, for example magnetic, magneto-optical disks, or optical disks. However, a computer need not have such devices. Devices suitable for storing computer program instructions and information/data include all forms of non-volatile memory, media and memory devices, including by way of example semiconductor memory devices, for example EPROM, EEPROM, and flash memory devices; magnetic disks, for example internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, for example, a CRT (cathode ray tube) or LCD (liquid crystal display) monitor, for displaying information/data to the user and a keyboard and a pointing device, for example, a mouse or a trackball, by which the user can provide input to the computer. Other kinds of devices can be used to provide for interaction with a user as well; for example, feedback provided to the user can be any form of sensory feedback, for example visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s client device in response to requests received from the web browser.

Embodiments of the subject matter described herein can be implemented in a computing system that includes a back-end component, for example, as an information/data server, or that includes a middleware component, for example, an application server, or that includes a front-end component, for example, a client computer having a graphical user interface or a web browser through which a user can interact with an embodiment of the subject matter described herein, or any combination of one or more such back-end, middleware, or front-end components. The components of the system can be interconnected by any form or medium of digital information/data communication, for example, a communication network. Examples of communication networks include a local area network (“LAN”) and a wide area network (“WAN”), an inter-network (for example the Internet), and peer-to-peer networks (for example ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (for example, an HTML page) to a client device (for example, for purposes of displaying information/data to and receiving user input from a user interacting with the client device). Information/data generated at the client device (for example, a result of the user interaction) can be received from the client device at the server.

While this specification contains many specific embodiment details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

Many modifications and other examples as set forth herein will come to mind to one skilled in the art to which these embodiments pertain to having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation. A number of example implementations have been described. Nevertheless, it will be understood that various modifications may be made without departing from the spirit and scope of the disclosure. Accordingly, additional implementations are within the scope of the following claims.

What is claimed:

1. A method for adaptive thermal control of a micro-ring modulator in a photonic link, comprising:
receiving a modulation data signal for driving the micro-ring modulator;
generating a reference power value based on a duty cycle of the modulation data signal;
sensing an average optical power at a drop port of the micro-ring modulator;
comparing the sensed average optical power to the generated reference power value to produce an error signal; and
using the error signal to regulate a heater associated with the micro-ring modulator to maintain a resonant wavelength of the micro-ring modulator.

2. The method of claim 1, further comprising:
synchronizing a timing of the generated reference power value with a timing of the sensed average optical power by introducing delay elements to compensate for associated propagation delays.

3. The method of claim 1, wherein calculating the duty cycle comprises applying a low-pass filter to the modulation data signal to obtain a time-averaged value representative of the duty cycle.

4. The method of claim 1, wherein generating the reference power value is performed in a digital domain.

5. The method of claim 1, wherein generating the reference power value is performed in an analog domain.

6. The method of claim 1, wherein generating the reference power value is performed in a hybrid domain comprising analog and digital processing.

7. The method of claim 1, wherein sensing the average optical power comprises:
converting optical power at the drop port to an electrical current using a photodiode; and
converting the electrical current to a voltage using a transimpedance amplifier.

8. The method of claim 1, wherein regulating the heater comprises:
adjusting a voltage applied to the heater in response to the error signal to shift the resonant wavelength of the micro-ring modulator.

9. The method of claim 1, wherein the adaptive thermal control maintains an optical modulation amplitude at a maximum value regardless of changes in the modulation data signal or changes in environment.

10. The method of claim 1, wherein the reference power value is determined from a formula based on a duty cycle D and average optical power values P0 and P1, P0 and P1 corresponding respectively to logical data values 0 and 1 of the modulation data signal.

11. The method of claim 10, further comprising:
calibrating the values of P0 and P1 based on measuring respectively the average optical power at the drop port for the logical data values 0 and 1 of the modulation data signal.

12. An apparatus for adaptive thermal control of a micro-ring modulator in a photonic link, comprising:
a micro-ring modulator configured to receive a modulation data signal from a signal source;
an adaptive thermal control unit to receive the modulation data signal from the signal source and generate a reference power value based on a duty cycle of the modulation data signal;
a sensing circuit configured to sense an average optical power at a drop port of the micro-ring modulator;
an adder to produce an error signal from the sensed average optical power and the reference power value; and
a controller configured to use the error signal to regulate a heater associated with the micro-ring modulator, the controller maintaining a resonant wavelength of the micro-ring modulator based on using the error signal.

13. The apparatus of claim 12, further comprising delay elements configured to synchronize a timing of the generated reference power value with a timing of the sensed average optical power to compensate for associated propagation delays.

14. The apparatus of claim 12, wherein the apparatus includes a low-pass filter configured to process the modulation data signal to obtain a time-averaged value representative of the duty cycle.

15. The apparatus of claim 12, wherein the reference power generator is implemented in a digital domain, an analog domain, or a hybrid domain comprising analog and digital processing.

16. The apparatus of claim 12, wherein the sensing circuit comprises a photodiode configured to convert optical power at the drop port to an electrical current and a transimpedance amplifier configured to convert the electrical current to a voltage.

17. The apparatus of claim 12, wherein the controller is configured to adjust a voltage applied to the heater in response to the error signal, the controller shifting the resonant wavelength of the micro-ring modulator based on the voltage applied to the heater.

18. A non-transitory computer-readable medium storing instructions that, when executed by one or more processors of a control system, cause the control system to:
receive a modulation data signal for driving a micro-ring modulator;
generate a reference power value based on a duty cycle of the modulation data signal;
sense an average optical power at a drop port of the micro-ring modulator;
compare the sensed average optical power to the generated reference power value to produce an error signal; and
use the error signal to regulate a heater associated with the micro-ring modulator to maintain a resonant wavelength of the micro-ring modulator.

19. The non-transitory computer-readable medium of claim 18, wherein the instructions, when executed, further cause the control system to synchronize a timing of the generated reference power value with a timing of the sensed average optical power by introducing delay elements to compensate for associated propagation delays.

20. The non-transitory computer-readable medium of claim 18, wherein generating the reference power value based on the duty cycle comprises applying a low-pass filter to the modulation data signal to obtain a time-averaged value representative of the duty cycle.
